(19) United States
(12) Patent Application Publication
(10) Pub. No.: US 2004/0151972 A1
(43) Pub. Date: Aug. 5, 2004

(54) Flow field plates and a method for forming a seal between them

(76) Inventors: Mark Christopher Turpin, Loughborough Leicestershire (GB); James Charles Boff, Pinner Middlesex (GB); Brendan Michael Bilton, Heswall Wirral (GB)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/475,576

(22) PCT Filed: Apr. 16, 2002
(86) PCT No.: PCT/GB02/01762

(30) Foreign Application Priority Data
May 3, 2001 (GB) 0110920.6
Nov. 16, 2001 (GB) 0127522.1

(51) Int. Cl. H01M 8/02; H01M 8/10; H01M 2/08; H01M 4/94

(52) U.S. Cl. 429/38; 429/35; 429/44; 29/623.2; 429/32

(57) ABSTRACT

A flow field plate having a plurality of protrusions formed integrally on at least on surface, said protrusions being adapted in use to join the flow field plate to an adjacent flow field plate. The material of the plate may be an electrically conductive polymer, which may comprise a conductive filler and carbon nanofibres. The plates may be welded together by ultrasonic welding.

This invention relates to flow field plates for fuel cells or electrolysers, particularly, although not exclusively, for proton exchange membrane fuel cells or electrolysers.

Fuel cells are devices in which a fuel and an oxidant combine in a controlled manner to produce electricity directly. By directly producing electricity without intermediate combustion and generation steps, the electrical efficiency of a fuel cell is higher than using the fuel in a traditional generator. This much is widely known. A fuel cell sounds simple and desirable but many man-years of work have been expended in recent years attempting to produce practical fuel cell systems.

One type of fuel cell in commercial production is the so-called proton exchange membrane (PEM) fuel cell [sometimes called polymer electrolyte or solid polymer fuel cells (PEFCs)]. Such cells use hydrogen as a fuel and comprise an electrically insulating (but jonically conducting) polymer membrane having porous electrodes disposed on both faces. The membrane is typically a fluorosulphonate polymer and the electrodes typically comprise a noble metal catalyst dispersed on a carbonaceous powder substrate. This assembly of electrodes and membrane is often referred to as the membrane electrode assembly (MEA).

Fuel (typically hydrogen) is supplied to one electrode (the anode) where it is oxidised to release electrons to the anode and hydrogen ions to the electrolyte. Oxidant (typically air or oxygen) is supplied to the other electrode (the cathode) where electrons from the cathode combine with the oxygen and the hydrogen ions to produce water.

A sub-class of proton exchange membrane fuel cell is the direct methanol fuel cell in which methanol is supplied as the fuel. This invention is intended to cover such fuel cells and indeed any other fuel cell using a proton exchange membrane.

In commercial PEM fuel cells many such membrane electrode assemblies are stacked together in series separated by flow field plates (also referred to as bipolar plates). (An assembled body of flow field plates and membranes with associated fuel and oxidant supply manifolds is often referred to a fuel cell stack). The flow field plates are typically formed of metal or graphite to permit good transfer of electrons between the anode of one membrane and the cathode of the adjacent membrane.

Metal flow field plates were disclosed in U.S. Pat. No. 3,134,696. Although having a high electrical conductivity, such plates are at risk of corrosion from the chemicals within the fuel cell.

The use of carbon/fluorocarbon polymer composites has been described in U.S. Pat. No. 4,214,969. However, polymers containing even a low loading of conductive particles suffer from strength problems, and therefore the addition of a further component such as carbon fibre, as disclosed in U.S. Pat. No. 4,339,322, is necessary to provided adequate materials properties.

Compressible graphite may also be used, as disclosed in WO 95/16287. WO 00/41260 claims that this is particularly suitable for forming fine-surface features by methods such as moulding, rolling or embossing. The low conductivity of such materials is a drawback to their use and the compressibility of the material leads to low mechanical strength. Additionally, compressible graphite materials suffer from the problem that they are compressible! When the stack is assembled the cells are compacted at very high loads (200 N/cm² is typical). Such materials are not dimensionally stable under this pressure and the gas tracks tend to close up.

The use of carbon/polymer composites has been proposed. U.S. Pat. No. 6,039,852 refers to a composite material comprising a mixture of graphite or conductive powder and a thermoplastic polymer. However, such materials are relatively low in strength and require a supporting frame.

U.S. Pat. No. 4,554,063 also discloses the manufacture of porous electrodes, for membrane electrolysis processes, from conductive graphite powder and carbon fibres with a flurocarbon polymeric binder. The strength of these materials is enhanced at no improvement to the conductivity by the use of carbon fibres to reinforce the electrode. However, high loadings of both particles and fibres can lead to problems with plate processing and the porous materials resulting are not suitable for use as flow field plates in a fuel cell as reactants from one side of the flow field plate can mix with reactants from the other side.

Fluorocarbon polymers are also expensive and a lower cost solution is desired.

All of the above mentioned materials and processes have drawbacks of various sorts. It would be advantageous to have a dimensionally stable, highly conductive, mechanically strong material that could be processed by conventional techniques to give fine-featured flow field plates. It would be still more advantageous if such a material were formable by high volume/low cost techniques such as injection moulding.

A further aspect to consider is the manner in which the flow field plate and membrane electrode assemblies are joined together to form a fuel cell stack. It is necessary to form a non-porous seal between each component to prevent the escape of any gas. This is done by providing a gasket assembly at the periphery of each plate, whereby the plates and membranes are sealed together.

EP0933826 discloses a method of forming a fuel cell stack containing series of cells comprising a positive electrode, an electrolyte plate, a negative electrode and separated by a separator plate, wherein an elastomer layer is adhered to the separator plate by an adhesive layer. Such a method is time consuming to apply, and the efficacy of such a seal is limited by the ability of the adhesive to prevent any gas escape.

U.S. Pat. No. 5,298,342 discloses a method of sealing a cell, wherein the metal foil of the membrane electrolyte assembly also forms part of the peripheral seal with a resilient material. Here the seal is formed by the resilient material extending through the foil, forming an impermeable seal. The disadvantage of this is that the resilient material must also be applied to the separator and flow field plates.

WO00/54352 describes fuel cell sealing system wherein a silicone rubber seal is formed directly on to the proton exchange membrane by moulding, and adhered to the anode and the cathode. Again, this method involves the application of the resilient material to the membrane.

WO00/30203 disclosed a method of manufacturing fuel cell collector plates which comprised the use of polymer bonded high graphite materials (containing 45-95% by weight graphite powder, 5-50 wt % polymer resin and 0-20 wt % of fibrous filler, which may be nanofiber). Because of the high graphite loading high forming pressures are required. No disclosure of the formation of welding protrusions or sealing features is made.

WO97/50139 discloses a bipolar plate for a polymer electrolyte membrane fuel cell in which a conductive insert is moulded into a melt processable frame and in which gas passages are provided in the conductive insert.

WO01/80339 discloses a bipolar plate for a polymer electrolyte membrane fuel cell in which a conductive polymer insert is moulded into a non-conductive polymer frame and in which gas passages are provided in the non-conductive frame. Special tools are used to weld in the area surrounding ports through the plates. WO01/80339 discloses the use of ultrasonic welding to weld adjacent plates together but does not disclose the use of welding protrusions or formed sealing features to provide sealing.

An attractive solution to this problem would be to provide a method of forming a gas-impermeable seal without the need for any type of gasket, and with the minimum number of processing steps.

GB 2006101 discloses the use of ultrasonic welding of sealing features in a fuel cell construction comprising a polymer frame with metal gauze electrodes surrounding a void, but was not concerned with sealing flow field plate separators and did not disclose the use of welding pips. So far as the applicants are aware the use of welding pips and sealing features to facilitate ultrasonic welding of flow field plate separators has not been proposed.

The applicants have realised that what is required are flow field plates formed from a highly electrically conductive material, which may be joined and sealed together without the need for a gasket or other external sealing means.

Accordingly, the present invention provides a flow field plate having a plurality of protrusions formed integrally on at least one surface, said protrusions being adapted in use to join the flow field plate to an adjacent flow field plate.

The protrusions may comprise sealing features.

Advantageously the material of the flow field plate is such that it may be welded to the adjacent plate.

The flow field plates may comprise integrally formed protrusions or indentations adapted to engage with complementary protrusions on an adjacent plate.

The flow field plates may comprise one or more electrically conductive inserts in a non-conductive frame, and fluid manifolds may be formed in the one or more electrically conductive inserts, or in the non-conductive frame, or both. The electrically conductive inserts may comprise an electrically conductive polymeric composite material, or may be any other suitable conductive material.

The invention further provides a method of forming a seal between at least two such flow field plates, comprising, stacking the plates together and welding them together, preferably using ultrasonic means.

The invention further provides a fuel cell sub-assembly comprising one such flow field plate, at least one gas diffusion layer and at least one membrane electrode assembly.

The invention is illustrated by way of example in the following description, with reference to the drawings, in which:

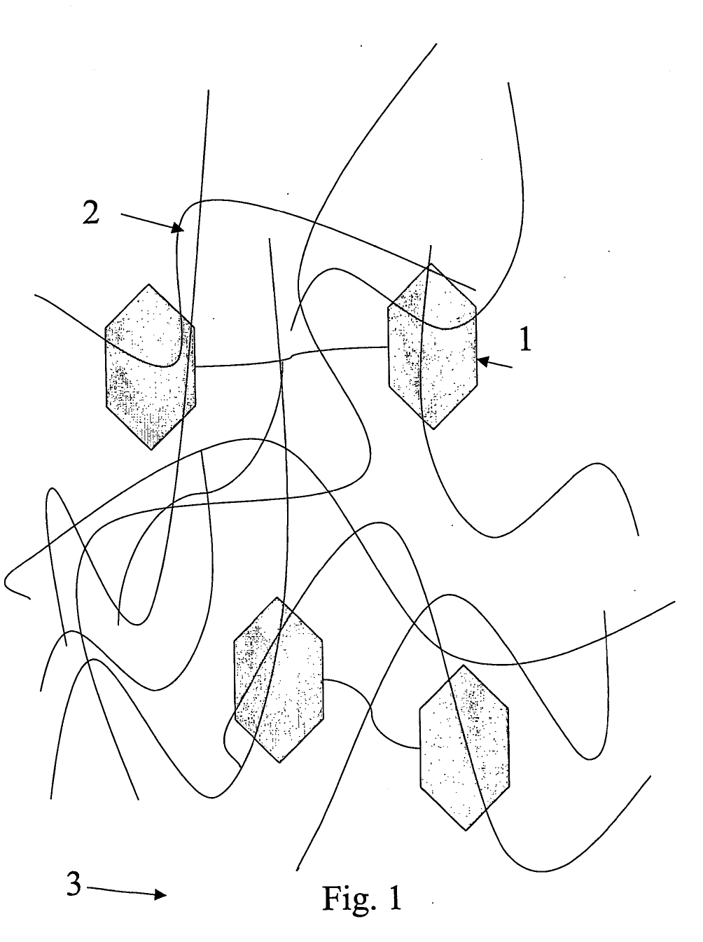

FIG. 1 is a schematic representation of a material usable with the invention;

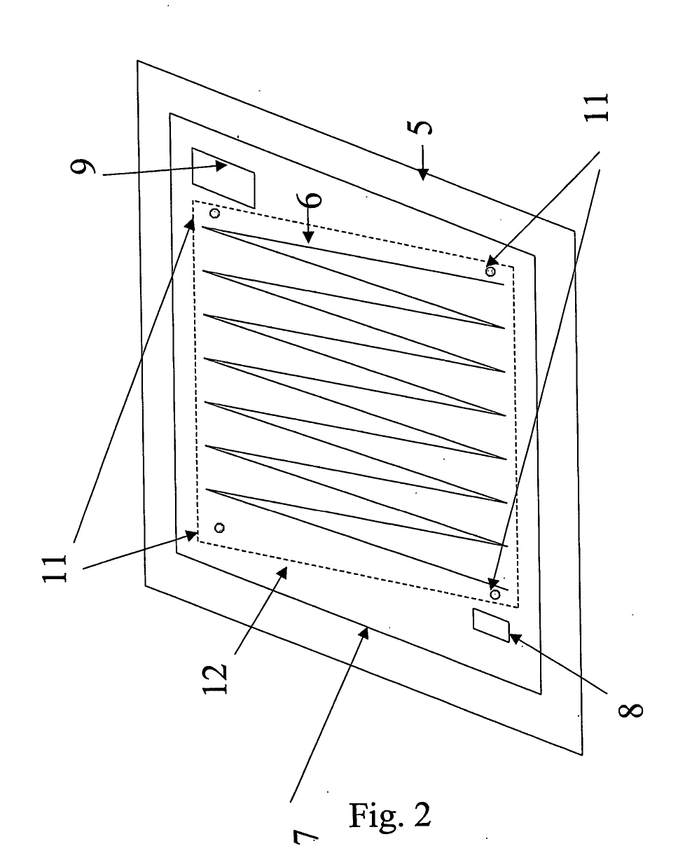

FIG. 2 is a schematic representation of a flow field plate in accordance with the invention.

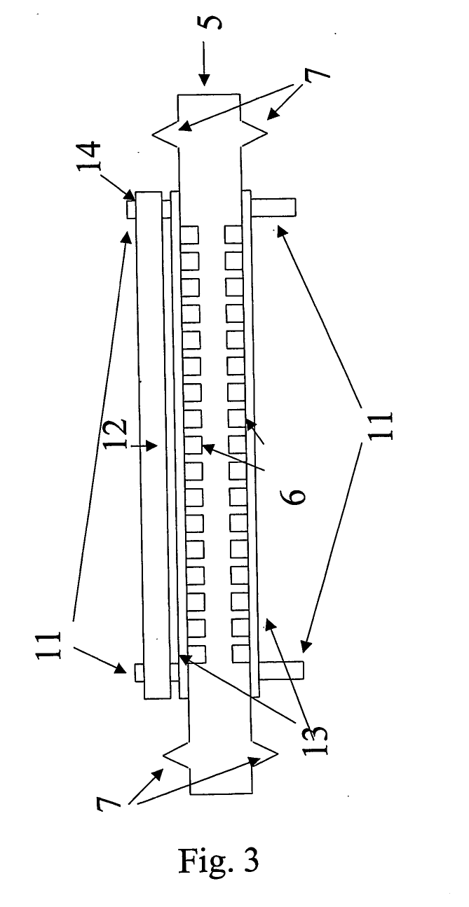

FIG. 3 is a schematic representation of the cross-section of a fuel cell sub-assembly in accordance with the invention.

The injection mouldable material used to form the plates needs to be highly electrically conductive. Inherently electrically conductive polymers may be used, or polymers (conductive or not) loaded with conductive fillers to provide a desired conductivity.

The composition may comprise a polymer matrix, a conductive filler (for example, graphite) and carbon nanotubes. The conductivity of such a material is enhanced by the electrical interconnection between the nanofibres and the electrically conductive particles.

In FIG. 1 electrically conductive particles 1 and electrically conductive nanofibres 2 are distributed in a matrix 3. The electrically conductive particles 1 are present at a sufficiently low concentration that they are not in contact with each other. The nanofibres 2 are present in sufficient amounts that they form an electrically conductive network, any given nanofibre 2 being in contact with several other nanofibres 2 and perhaps with one or more particles 1.

The polymer may be thermosetting or thermoplastic as the intended application of the composition demands.

Master batches of polymer containing 15-25% carbon nanotubes are commercially available, for example from Hyperion Catalysis International, Cambridge, Boston, Mass., USA (see www.fibrils.com).

Essentially any polymer can be produced with nanofibre loading. Typically, in use, a master batch would be diluted to a nanofibre concentration 1 to 25%, preferably 3-10% by weight. The nanofibre diameters are typically of the order of 10 nm to 15 nm with an aspect ratio of typically 100 to 1000.

Addition of nanotubes alone modifies polymer properties considerably. Additions of nanotubes to polybutylene terephthalate (PBT) at a 5 wt % level modifies the base polymer properties as indicated in Table 1

TABLE 1

| | | Base polymer |
|---|---|---|
| | Base polymer | containing nanotubes |
| Strength (MPa) | 55 | 66 |
| Modulus (GPa) | 2.7 | 3.2 |
| Volume resistivity (Ωcm) | 10¹⁴ | 10¹ |

These changes are beneficial for increased materials strength and electrical conductivity, but do not of themselves provide a highly electrically conductive material. When combined with a conductive particle the conductive network of nanotubes and conductive particle leads to the enhanced electrical properties needed for a bipolar plate. To achieve a highly electrically conductive network with nanotubes alone would require extremely high loadings of nanotubes, which would be prohibitively expensive. By relying on the interaction between the nanotubes and the conductive particles the present invention allows the loadings of both constituents to be kept low while providing a formable and highly conductive material.

The amount of conductive particle required typically range up to 50% by weight, typically from 3 to 50% by weight, preferably from 10 to 40% by weight. Typical materials for this are, for example, graphite, exfoliated graphite and chopped carbon fibre.

The conductive particles are at least 100 times greater in size than the diameter of the nanofibres, preferably 1,000 times greater in size than the diameter of the nanofibres and still more preferably 10,000 times greater in size than the diameter of the nanofibres. The conductive particles may range in size from 1 μm to 2 mm, and typically from 100 μm to 500 μm. The most suitable particle size for this application is typically a balance between being large enough to permit ready wetting and incorporation in the polymer, and small enough to permit injection moulding with an acceptable finish.

Carbon black may also be included as a conductive particulate additive. Carbon black has nanometric dimensions, and so falls outside the size range for the conductive particles mentioned above.

Other materials that could be usable include any electrically conductive polymer that does not react detrimentally to the materials of the membrane electrode assembly, for example the materials disclosed in WO01/80339, WO01/60593, GB2198734, U.S. Pat. No. 6,180,275, WO00/30202, WO00/30203, WO00/25372, and WO00/44005.

In FIG. 2 a flow field plate 5 is shown having a flow field 6 formed in its surface, and sealing ridges 7, 8, 9 standing proud of its surface and formed integrally with the material of the flow field plate 5. The flow field plate may be formed by injection moulding or pressing a suitably conductive and plastic material. To form a sealed unit, two or more plates are stacked together sandwiching one or more membrane electrode assemblies between the plates. The plates may be joined by thermal treatment provided that the material of the membrane electrode assembly will resist the treatment temperature. Advantageously however the plates may be welded ultrasonically which allows a wider range of membrane materials to be used. The plates may comprise one or more electrically conductive inserts and a non-conductive frame. Such an arrangement may be created by insert injection moulding the non-conductive frame onto the electrically conductive inserts, by injection moulding the electrically conductive inserts into the frame, by welding the parts together, or by any other appropriate means. Fluid manifolds (for reactant gases and coolants) can be positioned in the one or more electrically conductive inserts, or in the non-conductive frame, or both.

The flow fields may be of conventional serpentine, linear or interdigitated form or any other form (e.g. a branched flow field) that effectively delivers reactant gas to the membrane electrode assembly.

A membrane electrode assembly 12 is interposed between the two flow field plates before welding. Protrusions 11 are provided to engage the periphery of the membrane, with the two plates effectively joined through the membrane material.

In FIG. 3 a fuel cell sub-assembly comprising gas-diffusion layers 13, a flow field plate 5 with sealing ridges 7, and a membrane electrode assembly 12 is shown. A flow field 6 is formed on the surface of both faces of the flow field plate. Gas diffusion layers are provided on either side of the flow field plate to transport gases from the flow field to the membrane electrode assembly and vice versa. The membrane electrode assembly is mounted on the protrusions 11 which are fitted into apertures 14 on the membrane, easily locating the membrane within the sealing ridges of the flow field plate. Fuel cells found in the prior art form a gasket seal through the membrane electrode assembly. This is unsatisfactory, as the membrane material is porous, and therefore the location of the membrane is crucial to the efficacy of the seal. The flow field plate in accordance with the present invention allows the location of the membrane without interference with the seal between flow field plates, thus ensuring that the seal is impermeable.

Several fuel cell sub-assemblies comprising at least one gas diffusion layer, a flow field plate, and at least one membrane electrode assembly, may be placed together and welded to form a fuel cell stack. If the geometry of the flow field permits, the gas diffusion layer may be disposed of.

The method of the present invention allows the formation of a gas impermeable seal between flow field plates without the need for any gasket assemblies, thus reducing processing time and manufacturing costs. The seal formed by this method is also highly effective. The invention should not be seen as being limited to polymer electrolyte fuel cells, as electrodes and separator plates for other types of fuel cells, may also be joined and sealed using this method.

1. A flow field plate having a plurality of protrusions formed integrally on at least one surface, said protrusions being adapted in use to join the flow field plate to an adjacent flow field plate.

2. A flow field plate as claimed in claim 1, wherein the protrusions comprise sealing features.

3. A flow field plate as claimed in claims 1 and 2 wherein the plate may further comprise protrusions or indentations adapted to engage with complementary protrusions on an adjacent plate.

4. A flow field plate as claimed in any preceding claim, wherein the material of the plates is such that it may be welded to the adjacent plate.

5. A flow field plate as claimed in claim 4, wherein the material of the plate is an electrically conductive polymer.

6. A flow field plate as claimed in claim 5, wherein the electrically conductive polymer material comprises:
a) a polymer matrix,
b) a conductive filler, and
c) carbon nanofibres.

7. A flow field plate as claimed in any of claims 1 to 4, in which the flow field plate comprises one or more electrically conductive inserts in a non-conductive frame.

8. A flow field plate as claimed in claim 7, in which fluid manifolds are formed in the non-conductive frame.

9. A flow field plate as claimed in any preceding claim in which the flow field is branched.

10. A method of forming a seal between two flow field plates as claimed in any preceding claim, comprising, stacking the plates together and welding them together.

11. A method as claimed in claim 10, in which the welding is by ultrasonic welding.

12. A method as claimed in claim 10 or claim 11, wherein one or more membrane electrode assemblies are sandwiched between the plates.

13. A method as claimed in claim 12, in which the membrane electrode assemblies comprise apertures disposed to engage with protrusions on the flow field plate.

14. A fuel cell sub-assembly comprising a flow field plate as claimed in any of claims 1 to 8, at least one gas diffusion layer and at least one membrane electrode assembly.

15. A fuel cell stack comprising at least two fuel cell sub-assemblies as claimed in claim 14.

16. A fuel cell stack comprising at least two flow field plates as claimed in any of claims 1 to 8 welded together, and one or more membrane electrode assemblies disposed between the flow field plates.
